(19) United States
(12) Patent Application Publication
(10) Pub. No.: US 2026/0195777 A1
(43) Pub. Date: Jul. 9, 2026

(54) USING ARTIFICIAL INTELLIGENCE TO DETECT FRAUDULENT ACTIONS ON AN ONLINE COMPENSATION MANAGEMENT SYSTEM

(71) Applicant: UKG Inc., Weston, FL (US)

(72) Inventors: Jill Colleen Deems, Seattle Beach, FL (US); Dani Van Camp, Parkland, FL (US)

(21) Appl. No.: 19/013,177

(22) Filed: Jan. 8, 2025

(51) Int. Cl. G06Q 30/018; G06Q 40/02; G06Q 40/12

(52) U.S. Cl. CPC G06Q 30/0185; G06Q 40/02; G06Q 40/125

(57) ABSTRACT

A method for using AI to detect fraudulent actions on an online compensation management system includes obtaining one or more digital records that include data indicating an action performed by a user associated with an online compensation management system of an organization, generating AI model input data based on the digital records, determining, using an AI model and using the AI model input data as input, whether the digital records indicate that at least one action performed by at least one user is fraudulent, and responsive to the digital records indicating that the at least one action performed by the at least one user is fraudulent, performing a corrective action to protect the online compensation management system of the organization.

### TECHNICAL FIELD

Embodiments of the present disclosure relate to computing systems, and more specifically, to systems and methods for using artificial intelligence to detect fraudulent actions on an online compensation management system.

### BACKGROUND

Organizations–especially small-size businesses and medium-size businesses, and non-profit organizations–often do not have sufficient computing resources and human personnel to develop software services used to maintain and support such organizations (e.g., human resources services, payroll and other financial services, regulatory compliance services, personnel management services, etc.) fully in-house and often rely on specialized outside developers and providers of these services. Such providers may furnish, to client businesses and organizations, various hardware and software computing resources (e.g., cloud-based and/or local) that automate a significant number of software services tasks.

### BRIEF DESCRIPTION OF THE DRAWINGS

The disclosure is illustrated by way of example, and not by way of limitation, and can be more fully understood with references to the following detailed description when considered in connection with the figures, in which:

FIG. 1 illustrates a high-level component diagram of an example system architecture, in accordance with one or more embodiments of the present disclosure.

FIG. 2A illustrates an example dataflow for generating an artificial intelligence (AI) model input for detecting fraudulent actions on an online compensation management system, in accordance with one or more embodiments of the present disclosure.

FIG. 2B illustrates an example dataflow for using an AI model to detect fraudulent actions on an online compensation management system, in accordance with one or more embodiments of the present disclosure.

FIG. 3 illustrates an example AI training subsystem, in accordance with one or more embodiments of the present disclosure.

FIG. 4 illustrates an example AI inference subsystem, in accordance with one or more embodiments of the present disclosure.

FIG. 5 illustrates an example method for using AI to detect fraudulent actions on an online compensation management system, in accordance with one or more embodiments of the present disclosure.

FIG. 6 is a block diagram illustrating a computing system in which implementations of the disclosure can be used.

### DETAILED DESCRIPTION

An organization may use an online compensation management system to manage the organization’s compensation-related data and processes. For example, the compensation management system may store data relating to the organization’s users’ direct deposit data, compensation management system login data, benefits and taxes data, timekeeping data, or the like. The compensation management system may perform compensation-related processes such as setting up a new user for employment at the organization, run payroll, or other processes. Sometimes, a user of the compensation management system may use the system to perform fraudulent actions. For example, if a user is terminated from the organization, a supervisor may not remove the terminated user from the compensation management system (making it appear that the user is still employed by the organization) and may change the terminated user’s direct deposit information to match that of the supervisor, resulting in the organization compensating the supervisor using the terminated employee’s compensation. Conventional compensation management systems may have some fraud detection capabilities, but these may be limited.

Aspects and implementations of the instant disclosure address the above-mentioned and other challenges of the existing technology by providing systems and methods that use artificial intelligence (AI) models to analyze digital records used by an online compensation management system to detect fraudulent actions performed by users of the system. The online compensation management system may then perform corrective actions to protect the system. The compensation management system may obtain one or more digital records that include data indicating actions performed by users of the system. The compensation management system may use the digital records as input to an AI model. The AI model may be trained, programmed, and/or configured to determine whether the input indicates that an action performed by a user of the system is fraudulent. For example, the AI model may use digital records indicating direct deposit information associated with users of the system as input, perform an inference calculation, and determine that the input indicates that a supervisor has changed a user’s direct deposit information to match that of the supervisor’s. The compensation management system may then protect the system from the fraudulent action by preventing a user from completing the fraudulent action or by generating an alert for an administrator of the system that notifies the administrator of the fraudulent action.

The advantages of the disclosed techniques include but are not limited to the automatic and accurate detection of fraudulent actions performed by a user of the compensation management system. By using AI models to analyze digital records of the compensation management system, the system can detect fraudulent user actions more accurately than convention compensation management systems. Furthermore, by accurately and automatically detecting fraudulent actions by a user of the compensation management system, the system can automatically prevent the completion of the fraudulent actions, which improves the security of the compensation management system. Advantages of the disclosed techniques include compensation management systems that are more accurate in detecting fraudulent actions performed by users and that are more secure.

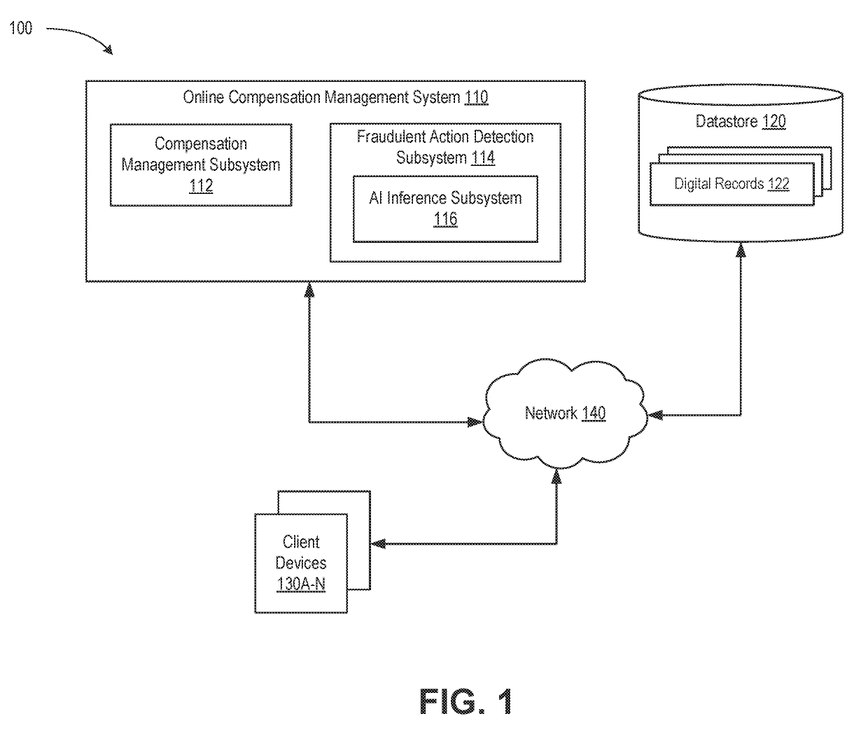

FIG. 1 illustrates a high-level component diagram of an example system architecture 100, in accordance with one or more aspects of the present disclosure. The system architecture 100 (also referred to as the “system” herein) includes an online compensation management system 110, a datastore 120, one or more client devices 130A-N, and/or other components connected to a network 140. In some embodiments, any of the online compensation management system 110 and/or client device(s) 130A-N may include one or more desktop computers, laptop computers, smartphones, tablet computers, servers, or any suitable computing devices capable of performing the techniques described herein.

In some implementations, the online compensation management system 110 may provide compensation management services that include payroll and other financial services, personnel management services (e.g., employee time and attendance services, employee scheduling services, employee benefits services, or the like), human resources (HR) services, regulatory compliance services, or other services related to management compensation for an organization and its personnel. The online compensation management system 110 can include one or more computing devices (such as rackmount servers, router computers, server computers, personal computers, mainframe computers, networks, software components, or hardware components that may be used to provide a user with access to data or services. Such computing devices may be positioned in a single location or may be distributed among many different geographical locations. For example, the online compensation management system 110 may include multiple computing devices that together may comprise a hosted computing resource, a grid computing resource or any other distributed computing arrangement. In some implementations, the online compensation management system 110 may correspond to an elastic computing resource where the allotted capacity of processing, network, storage, or other computing-related resources may vary over time.

In an illustrative example, the online compensation management system 110 can be a software-as-a-service (SaaS) platform that can provide compensation management services to its customers. The SaaS platform may deploy services, such as software applications, to one or more clients for use as an on-demand service. For example, the SaaS platform may deliver and/or license software applications on a subscription basis while also hosting the software application. The licensed software applications can be hosted on an infrastructure, such as cloud computing resources of the SaaS platform.

In one implementation, an organization can be a customer of the online compensation management system 110. An example of an organization may be a legal entity. In some implementations, an organization can be associated with an account (e.g., organizational account) of the online compensation management system 110. Within the particular account of the organization, one or more sub-accounts of the online compensation management system 110 may be associated with different users of the organization. In some implementations, the accounts are organized in a hierarchical structure where the organizational account is the root at the top of the hierarchy and the user accounts are nested under the organizational account. The online compensation management system 110 may include an account management system that manages accounts of the online compensation management system 110. Managing accounts may include functionality related to account creation, account deactivation, account suspension, account modification, or other functionality.

In some implementations, one or more client devices 130A-N can communicate with the online compensation management system 110 using function calls, such as application programming interface (API) function calls. For example, the one or more function calls can be identified in a request using one or more application layer protocols, such a HyperText Transfer Protocol (HTTP) (or HTTP secure (HTTPS)), and that are sent to the online compensation management system 110 from a client device 130A using a software application (e.g., a web browser, mobile application, or the like). In some implementations, the online compensation management system 110 can respond to the requests from the client device 130A by using one or more API responses using an application layer protocol.

In one embodiment, the online compensation management system 110 may include a compensation management subsystem 112. The compensation management subsystem 112 may include software that performs one or more tasks or functionality according to the executable code of the compensation management subsystem 112. Examples of the compensation management subsystem 112 can include software services used to manage and support compensation services for small- or medium-size businesses (e.g., payroll and other financial services, personnel management services, regulatory compliance services, etc.). The compensation management subsystem 112 may include other types of functionalities, operations, or the like for performing other types of tasks. The compensation management subsystem 112 may include a single software program or may include multiple software programs in data communication with each other that collaborate to perform the tasks and functionality of the compensation management subsystem 112.

In one embodiment, the compensation management subsystem 112 may generate, receive, or maintain one or more digital records. A digital record may include data indicating an action performed by a user associated with the online compensation management system 110. In some embodiments, an action performed by a user may include the user logging into the online compensation management system 110. A digital record associated with the user logging into the online compensation management system 110 may include data indicating the username of the user on the online compensation management system 110, a date and/or time of the log in, an internet protocol (IP) address or other device identifier of a client device 130 used to perform the log in, or other login information.

An action performed by a user may include setting up an account for a user on the online compensation management system 110. Digital records associated with setting up an account for a user may include data indicating the user’s biographical information (e.g., name, marital status, etc.), contact information (e.g., residence or mailing address, phone number, email address, etc.), employment status (e.g., full-time, part-time, contract, terminated, etc.), employment position, banking information (e.g., direct deposit information, bank account information, etc.), or other information about the user. The user may perform actions to set up their own account, or another user (e.g., an administrator user of the online compensation management system 110) may perform the actions. An action performed by a user may include changing information associated with a user’s account on the online compensation management system 110 (e.g., the user may change their own information or an administrator of the online compensation management system 110 may change another user’s information). An action performed by a user may include setting up or modifying benefit, tax, or tax deduction information.

In some embodiments, an action performed by a user may include setting up or modifying employment information on the online compensation management system 110 for a user. Digital records associated with setting up or modifying employment information may include data indicating a user’s employment position, relation to other users (e.g., supervisor, manager, etc.), team, etc. The digital records may include data indicating the user’s compensation information (e.g., salary, pay rate, pay frequency, bonus information, pay increases, etc.). The digital records may include the user’s hire date or date of termination. In one embodiment, a user action may include performing time and attendance actions. Digital records associated with time and attendance actions may include a clock-in time and date, a clock-out time and date, a time off request (which may indicate the times and/or dates for which time off is requested).

In one embodiment, a digital record may include data indicating a time and/or date that an action performed by a user was performed by the user. A digital record may include data indicating a time and/or date that information associated with the user and stored by the online compensation management system 110 was created, modified, or otherwise changed.

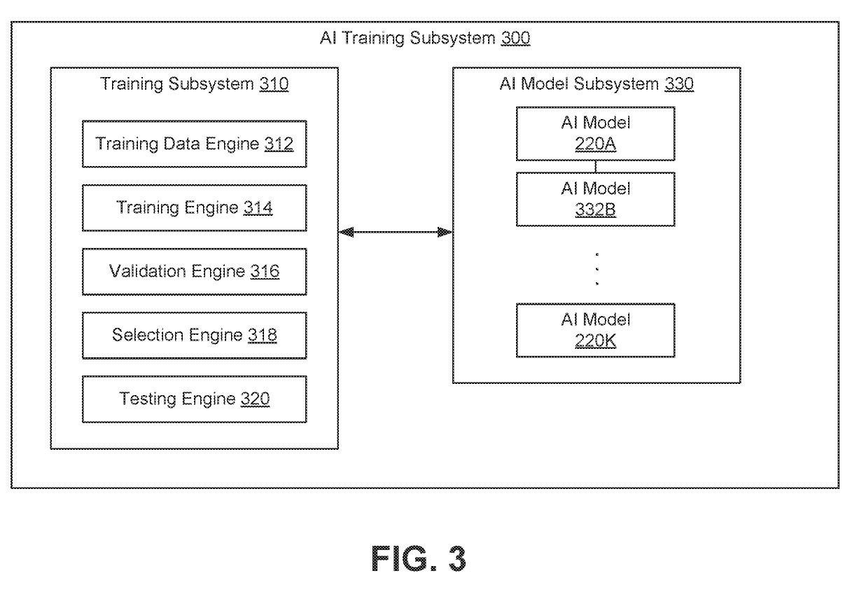

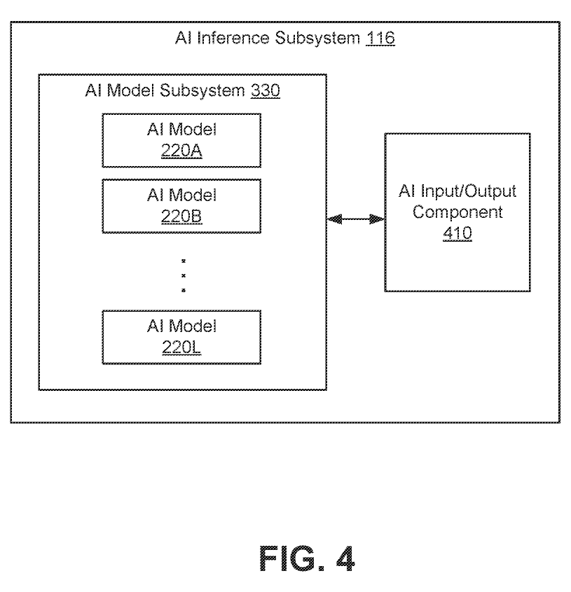

In some embodiments, the online compensation management system 110 may include a fraudulent action detection subsystem 114. The fraudulent action detection subsystem 114 may include software that analyzes data based on one or more digital records generated, received, or maintained by the compensation management subsystem 112. The fraudulent action detection subsystem 114 may determine, based on the analysis of the data based on the digital records, whether the analyzed data indicates that an action performed by a user is fraudulent. In one embodiment, the fraudulent action detection subsystem 114 may include an AI inference subsystem 116. The AI inference subsystem 116 may use one or more AI models trained, programmed, or configured to determine whether the data based on the digital records indicates that an action performed by a user is fraudulent. In some embodiments, the AI inference subsystem 116 may include the one or more AI models. In other embodiments, the AI inference subsystem 116 may include software that is in data communication (e.g., over the network 140) with one or more AI models external to the online compensation management system 110 (e.g., AI models hosted by a third-party server device), provides input to the external AI model(s) (e.g., via an application programming interface (API)), and receives responses from the AI model(s). Further information regarding the AI inference subsystem 116 and AI models is discussed below in relation to FIG. 3 and FIG. 4.

In one or more embodiments, the compensation management subsystem 112 and/or the fraudulent action detection subsystem 114 may include (or may have access to) instructions stored on one or more tangible, machine-readable storage media of the online compensation management system 110 and may be executable by one or more processing devices of the online compensation management system 110. In one embodiment, the compensation management subsystem 112 and/or the fraudulent action detection subsystem 114 may be implemented as a single component. In some embodiments, the compensation management subsystem 112 and/or the fraudulent action detection subsystem 114 may each be a client-based application located on a client device 130A-N.

In one embodiment, the compensation management subsystem 112 and/or the fraudulent action detection subsystem 114 may be a combination of a client component and a server component, with some portions of the compensation management subsystem 112 and/or the fraudulent action detection subsystem 114 executing on a client device 130A-N while another portion of the compensation management subsystem 112 and/or the fraudulent action detection subsystem 114 executes on the online compensation management system 110. In some embodiments, the compensation management subsystem 112 and/or the fraudulent action detection subsystem 114 may form part of a software-as-a-service (SaaS) offering provided by the entity that owns, operates, or controls the compensation management subsystem 112 and/or the fraudulent action detection subsystem 114. Users of the one or more client devices 130A-N may access the SaaS offering via an application (e.g., a web browser) running on the respective client devices 130A-N.

In one embodiment, the datastore 120 may be implemented in a persistent storage capable of storing files, data structures, databases, or other data storage formats, in accordance with implementations of the present disclosure. The datastore 120 may be hosted by one or more storage devices, such as main memory, magnetic or optical storage disks, tapes, or hard drives, network-attached storage (NAS), a storage area network (SAN), and so forth. Although depicted as separate from the online compensation management system 110, the datastore 120 may be part of the online compensation management system 110 and/or other devices of the system 100.

The datastore 120 may store various data and metadata used and/or generated by the compensation management subsystem 112 and/or the fraudulent action detection subsystem 114. In some embodiments, the datastore 120 may store one or more digital records 122. The one or more digital records 122 may include the digital records that include data indicating an action performed by a user associated with the online compensation management system 110, as discussed above. The datastore 120 may store the one or more digital records 122 in a database. The database may include a structured collection of data that is organized and stored electronically for access and management. The database can include a relational database, an object-oriented database, or some other type of database. The compensation management subsystem 112 and/or the fraudulent action detection subsystem 114 may store data in the database, retrieve data from the database, and modify data in the database as part of performing a task or other functionality. In some embodiments, end users of the client devices 130A-N may belong to different organizations (e.g., different businesses), and different portions of the database may be accessible to different end users based on which organization an end user belongs to. The online compensation management system 110 and/or the datastore 120 may enforce security mechanisms to prevent end users from accessing database data that the end users are not authorized to access. Such security mechanisms may include role-based access controls, row-level security, or other similar security mechanisms.

In one embodiment, each of the client device(s) 130A-N may include a computing device that a user of the online compensation management system 110 can use to interact with the online compensation management system 110 and perform actions on the online compensation management system 110. A client device 130 may include desktop computer, laptop computer, smartphone, tablet computer, or any suitable computing device capable of sending data to and receiving data from the online compensation management system 110. For example, as discussed above, the online compensation management system 110 may include a SaaS offering, and a user of a client device 130 may access the SaaS offering via an application running on the client device 130. The application may be a web browser, software application, mobile application, or another type of application.

In one or more embodiments, the user of a client device 130 may use the client device 130 to perform an action on the online compensation management system 110. The user may access the application running on the client device 130 and input data indicating an action on a user interface (UI) of the application. The application may generate one or more data packets based on the input data and send the data packets to the online compensation management system 110 over the network 140. The online compensation management system 110 may receive the data packets and generate and/or modify one or more digital records 122 based on the data from the data packets.

In some embodiments, the network 140 may be a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long-Term Evolution (LTE) network), and/or the like. In some embodiments, network 140 may include routers, hubs, switches, server computers, and/or a combination thereof.

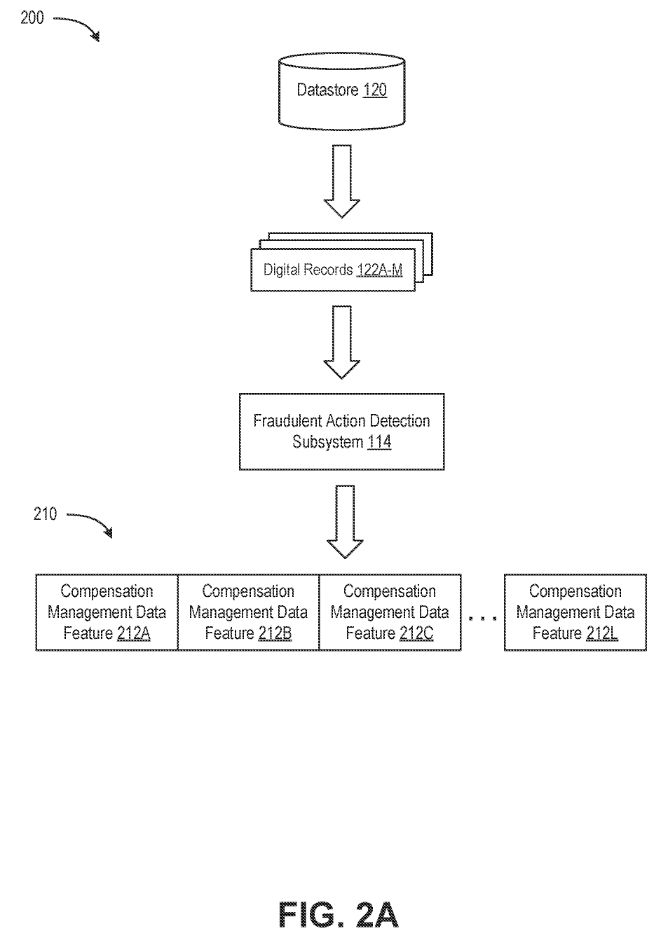

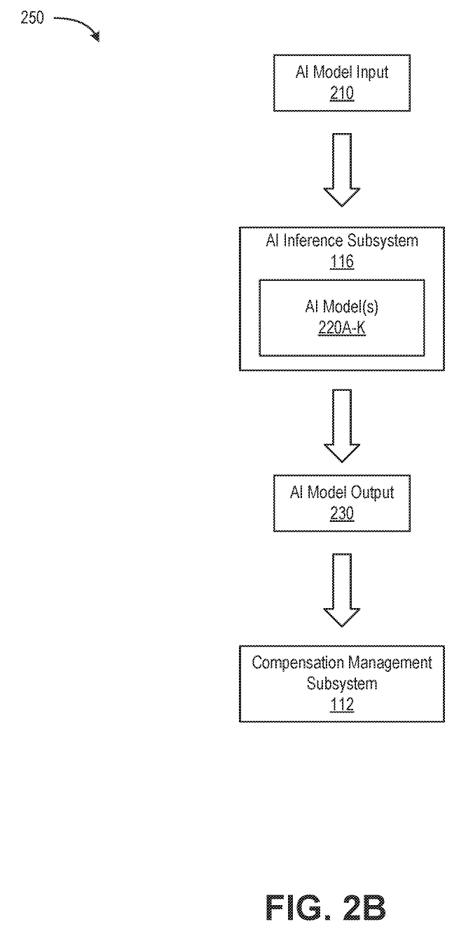

FIG. 2A illustrates an example dataflow 200 of generating an AI model input for detecting fraudulent actions on an online compensation management system 110, in accordance with some embodiments of the present disclosure. In one embodiment, the dataflow 200 may include the datastore 120 providing one or more digital records 122A-M to the fraudulent action detection subsystem 114.

In some embodiments, the datastore 120 may provide the one or more digital records 122A-M in response to receiving a request for the one or more digital records 122A-M from the fraudulent action detection subsystem 114. In some embodiments, the compensation management subsystem 112 may notify the fraudulent action detection subsystem 114 in response to a predetermined action being performed on the online compensation management system 110. In response to receiving the notification, the fraudulent action detection subsystem 114 may request the one or more digital records 122A-M. The notification may include data indicating the predetermined action. The predetermined action may include a user of the online compensation management system 110 performing an action. The predetermined action may include a specific type of action performed by a user. For example, the predetermined action type may include adding or changing banking information associated with a user of the online compensation management system 110. The predetermined action type may include setting up a new employee. The predetermined action type may include changing information associated with an employee. The predetermined action type may include another predetermined action discussed herein. In one or more embodiments, the fraudulent action detection subsystem 114 may request the one or more digital records 122A-M at a predetermined time interval. The predetermined time interval may be hourly, daily, weekly, or some other time interval.

In some embodiments, the one or more digital records 122A-M may be associated with a common aspect of the online compensation management system 110. For example, the common aspect may include a user, thus, the one or more digital records 122A-M may be associated with the same user. In another example, the common aspect may include a type of action. For example, the one or more digital records 122A-M may include data indicating banking account information changes associated with the employees of a certain organization. In some embodiments, the one or more digital records 122A-M may be associated with actions performed during a predetermined time interval (e.g., within the last day, week, pay period, month, etc.).

In one or more embodiments, a first digital record 122A of the one or more digital records 122A-M may be a digital record 122 that the online compensation management system 110 generated or modified within a threshold amount of time. For example, the first digital record 122A may include a digital record 122 that the online compensation management system 110 generated or modified within the previous second, 5 seconds, 30 seconds, 1 minute, 5 minutes, or some other amount of time. The first digital record 122A may indicate one or more actions a user of the online compensation management system 110 recently performed. In one embodiment, one or more second digital records 122B-M may include digital records 122 generated or modified by the online compensation management system 110 prior to generating the first digital record 122A. The one or more second digital records 122B-M may include data that is similar to the data contained in the first digital record 122A and may indicate one or more actions users of the online compensation management system 110 performed in the past. The fraudulent action detection subsystem 114 may use the first digital record 122A (representing a recent action) and the one or more second digital records 122B-M (representing one or more past actions) to determine whether the recent action and the past action(s) indicate a current or a history of fraudulent actions.

The fraudulent action detection subsystem 114 may obtain the one or more digital records 122A-M. The fraudulent action detection subsystem 114 may generate an AI model input 210 based on the one or more digital records 122A-M. The AI model input may include one or more compensation management data features 212A-L. A compensation management data feature 212 may include data indicated by a portion of the one or more digital records 122A-M. The fraudulent action detection subsystem 114 may calculate, compute, or determine the value of a compensation management data feature 212 based on data included in the one or more digital records 122A-M.

In one implementation, a compensation management data feature 212 may include bank account data. For example, a compensation management data feature 212 may indicate a number of users with the same banking information (e.g., same bank account number). A compensation management data feature 212 may indicate a number of users whose banking information was changed by the compensation management subsystem 112 within a predetermined amount of time. A compensation management data feature 212 may indicate an amount of time since a specific user’s banking information was modified.

In some embodiments, a compensation management data feature 212 may include employee login data. For example, a compensation management data feature 212 may indicate a number of times a specific user has logged into the online compensation management system 110 outside of a predetermined time interval. The predetermined time interval may include normal working hours for the user. The normal working hours for the user may be stored in a digital record 122 or in other data stored in the datastore 120. A compensation management data feature 212 may indicate one or more locations from which a user has logged into the online compensation management system 110.

In one embodiment, a compensation management data feature 212 may include employee payroll setup data. For example, a compensation management data feature 212 may indicate whether a specific user was hired, re-hired, terminated, or had another change of employment status within a predetermined time interval. A compensation management data feature 212 may indicate whether a specific user is associated with employment benefits, taxes, and/or tax deductions.

In some implementations, a compensation management data feature 212 may include employee payment history data. For example, a compensation management data feature 212 may indicate a specific user’s paid wages during a predetermined time interval. A compensation management data feature 212 may indicate a wage amount difference between users of the same title. A compensation management data feature 212 may indicate an amount of overtime wages paid to a specific user. A compensation management data feature 212 may indicate a history of a user’s wage increases. In one embodiment, a compensation management data feature 212 may include employee timekeeping data. For example, a compensation management data feature 212 may indicate time worked by a user during a predetermined time period (e.g., a day, a week, a month, a pay period, etc.). A compensation management data feature 212 may indicate an amount of time off a user has taken within a predetermined time interval.

In some embodiments, a compensation management data feature 212 may include employee data. For example, a compensation management data feature 212 may indicate whether multiple users have some of the same biographical information (e.g., name), contact information (e.g., mailing address, email address, etc.), or other information. A compensation management data feature 212 may indicate other data that the fraudulent action detection subsystem 114 calculates or determines based on the one or more digital records 122A-M. In some embodiments, the fraudulent action detection subsystem 114 may organize the one or more compensation management data features 212A-L into the AI model input 210.

FIG. 2B illustrates an example dataflow 250 of using one or more AI models for detecting fraudulent actions on an online compensation management system 110, in accordance with some embodiments of the present disclosure. The dataflow 250 may be a continuation of the dataflow 200 of FIG. 2A.

In one embodiment, the AI inference subsystem 116 may receive the AI model input 210, which may include the AI model input 210 generated in the dataflow 200. The AI inference subsystem 116 may include one or more AI models 220A-K. The one or more AI models 220A-K may be AI models trained, programmed, or otherwise configured to determine, based on input to the AI models, whether the input indicates that at least one action performed by at least one user of the online compensation management system 110 is fraudulent. The AI inference subsystem 116 may provide the AI model input 210 to one or more AI models 220A-K. The one or more AI models 220A-K may perform an inference calculation based on the AI model input 210 and generate an AI model output 230. The AI model output 230 may indicate whether the one or more digital records 122A-M used to generate the AI model input 210 indicate that at least one action performed by at least one user is fraudulent.

The fraudulent action detection subsystem 114 or the AI inference subsystem 116 may provide the AI model output 230 to the compensation management subsystem 112. In response to the AI model output 230 indicating at least one fraudulent action, the compensation management subsystem 112 may perform a corrective action. The corrective action may protect the online compensation management system 110.

In one embodiment, the compensation management subsystem 112 performing the corrective action may include the compensation management subsystem 112 causing the online compensation management system 110 to prevent a change to a digital record 122. In some embodiments, the compensation management subsystem 112 performing the corrective action may include causing the online compensation management system 110 to generate a fraudulent action alert. The alert may be presentable to an administrator of the online compensation management system 110 on a UI. The alert may provide information about the fraudulent action. The information about the fraudulent action may include the identities of one or more users associated with the fraudulent action, the type of fraudulent action (e.g., changing a user’s bank account information to match another user’s bank account information, a terminated user continuing the receive payment), a date and/or time the fraudulent action occurred, etc.

As an example, a user that is a manager for an organization may use the online compensation management system 110 to attempt to change a second user’s banking information to match the managing user’s banking information, which can be indicative of fraud (e.g., if the second user was previously terminated). The online compensation management system 110 may modify a digital record 122A that includes the second user’s banking information. The online compensation management system 110 may provide the modified digital record 122A to the fraudulent action detection subsystem 114. The online compensation management system 110 may provide other digital records 122B-M to the fraudulent action detection subsystem 114. The other digital records 122B-M may include digital records 122 indicating other users’ current banking information. The fraudulent action detection subsystem 114 may determine if the banking information indicated by the digital record 122A matches banking information indicated by the other digital records 122B-M. The fraudulent action detection subsystem 114 may generate a compensation management data feature 212A indicating whether the banking information matches another user’s banking information. The fraudulent action detection subsystem 114 may generate compensation management data features 212B-L indicating other data from the digital records 122A-M. The compensation management data features 212A-L may form an AI model input 210, which may be input into one or more AI models 220A-K. The one or more AI models 220A-K may generate an AI model output 230 that indicates that the digital records 122A-M indicate that the manager user’s actions are fraudulent. In response, the compensation management subsystem 112 may prevent the change to the digital records 122A indicating the second user’s banking information. The compensation management subsystem 112 may generate a fraudulent action alert and cause the alert to be presented on a UI of a client device 130 of an administrator of the online compensation management system 110. The alert may indicate the identity of the manager user and may indicate that the manager user attempted to change another user’s banking information to the manager user’s banking information. The alert may include an email, a text message, a push notification, or a notification provided on a UI associated with the online compensation management system 110 (e.g., a message in an internal inbox maintained by the online compensation management system 110).

FIG. 3 illustrates an example AI training subsystem 300, in accordance with implementations of the present disclosure. The AI training subsystem 300 may include one or more components configured to or programmed to train one or more AI models 220A-K. In some embodiments, the online compensation management system 110 may include the AI training subsystem 300. In one embodiment, the AI training subsystem 300 may be included on a third-party server device in data communication with the online compensation management system 110.

As illustrated in FIG. 3, the AI training subsystem 300 may include a training subsystem 310, which may include a training data engine 312, a training engine 314, a validation engine 316, a selection engine 318, or a testing engine 320. The AI training subsystem 300 may include an AI model subsystem 330. The AI model subsystem 330 may include one or more AI models 220A-K.

In one embodiment, the AI model 220A-K includes one or more of decision trees, random forests, artificial neural networks (ANNs), support vector machines (SVMs), clustering-based models, Bayesian networks, or other types of machine learning models. A random forest may include an AI model that includes multiple decision trees to make predictions. A decision tree may include a model that includes starts with a root node and branches that lead to child nodes based on specific conditions or splits on one or more features of input data. Each internal node tests an attribute, and each branch represents a possible outcome of the test. The process continues recursively until a leaf node is reached, which represents an output class. The decision tree’s structure may be determined through a top-down, greedy approach, where the best split at each node is selected based on a specific criterion. Each decision tree of the random forest may be trained on a random subset of data and may analyze a random subset of features when making splits.

ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one embodiment, an AI model 220A-K includes a generative AI model. A generative AI model can deviate from a machine learning model based on the generative AI model’s ability to generate new, original data, rather than making predictions based on existing data patterns. A generative AI model can include a generative adversarial network (GAN), a variational autoencoder (VAE), or a large language model (LLM). In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some embodiments, an AI model 220A-K is an AI model that has been trained on a corpus of data. In some embodiments, the AI model 220A-K can be a model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 220A-K to learn broad elements including, image or speech recognition, general sentence structure, common phrases, vocabulary, natural language structure, and other elements. In some embodiments, this first, foundational model is trained using self-supervision, or unsupervised training on such training datasets.

In some embodiments, the second portion of training, including fine-tuning, may be unsupervised, supervised, reinforced, or any other type of training. In some embodiments, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 220A-K while training can be ranked by a user, according to a variety of factors, including accuracy, helpfulness, veracity, acceptability, or any other metric useful in the fine-tuning portion of training. In this manner, the AI model 220A-K can learn to favor these and any other factors relevant to users when generating a response. Further details regarding training are provided below.

In some embodiments, an AI model 220A-K includes one or more pre-trained models, or fine-tuned models. In a non-limiting example, in some embodiments, the goal of the “fine-tuning” is accomplished with a second, or third, or any number of additional models. For example, the outputs of the pre-trained model can be input into a second AI model 220A-K that has been trained in a similar manner as the “fine-tuned” portion of training above. In such a way, two more AI models 220A-K can accomplish work similar to one model that has been pre-trained, and then fine-tuned.

As indicated above, an AI model 220A-K may be one or more generative AI models 220A-K, allowing for the generation of new and original content. The generative AI model 220A-K can use other machine learning models including an encoder-decoder architecture including one or more self-attention mechanisms, and one or more feed-forward mechanisms. In some embodiments, the generative AI model 220A-K includes an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model 220A-K can also utilize the previously discussed deep learning techniques, including RNNs, CNNs, or transformer networks. Further details regarding generative AI models 220A-K are provided herein.

In some embodiments, different AI models 220A-K of the one or more AI models 220A-K are different types of AI models 220A-K. Multiple AI models 220A-K of the one or more AI models 220A-K can form an ensemble.

In one embodiment, the training subsystem 310 manages the training and testing of the one or more AI models 220A-K. The training data engine 312 can generate training data (e.g., a set of training inputs and a set of target outputs) to train an AI model 220A-K. In an illustrative example, the training data engine 312 can initialize a training dataset T to null. The training data engine 312 can add the training data to the training dataset T and can determine whether training dataset T is sufficient for training the AI model 220A-K. The training dataset T can be sufficient for training the AI model 220A-K if the training dataset T includes a threshold amount of training data, in some embodiments. In response to determining that the training dataset T is not sufficient for training, the training data engine 312 can identify additional training data and add it to the training dataset T. In response to determining that the training dataset T is sufficient for training, the training data engine 312 can provide the training dataset T to the training engine 314.

The training engine 314 can train the AI model 220A-K using the training data (e.g., training dataset T). The AI model 220A-K can refer to the model artifact that is created by the training engine 314 using the training data, where such training data can include training inputs and, in some embodiments, corresponding target outputs (e.g., correct answers for respective training inputs). The training engine 314 can input the training data into the AI model 220A-K so that the AI model 220A-K can find patterns in the training data and configure itself based on those patterns.

In one embodiment, an item of the training dataset may include a training input and a target output. The training input may include an AI model input 210, which may include values for at least a portion of one or more compensation management data features 212. The values may include values indicating known instances of fraudulent actions. The target output of the item may include data indicating fraudulent actions. The output may include a Boolean value (e.g., “True” to indicate fraudulent action and “False” to indicate not fraudulent action). The output may include a value indicating a specific type of fraudulent action.

Where the AI model 220A-K uses supervised learning, the training engine 314 can assist the AI model 220A-K in determining whether the AI model 220A-K maps the training input to the target output (the answer to be predicted). Where the AI model 220A-K uses unsupervised learning, the training engine 314 can input the training data into the AI model 220A-K. The AI model 220A-K can configure itself based on the input training data, but since the training data may not include a target output, the training engine 314 may not assist the AI model 220A-K in determining whether the AI model 220A-K provided a correct output during the training process.

The validation engine 316 may be capable of validating a trained AI model 220A-K using a corresponding set of features of a validation set from the training data engine 312. The validation engine 316 can determine an accuracy of each of the trained AI models 220A-K based on the corresponding sets of features of the validation set. Where the training data may not include a target output, validating a trained AI model 220A-K may include obtaining an output from the AI model 220A-K and providing the output to another entity for evaluation. The other entity may include another AI model configured to evaluate the output of the AI model that is undergoing training. The other entity may include a human. The validation engine 316 can discard a trained AI model 220A-K that has an accuracy that does not meet a threshold accuracy or that otherwise fails evaluation. In some embodiments, the selection engine 318 is capable of selecting a trained AI model 220A-K that has an accuracy that meets a threshold accuracy. In some embodiments, the selection engine 318 is capable of selecting the trained AI model 220A-K that has the highest accuracy of multiple trained AI models 220A-K. In some embodiments, the selection engine 318 obtains input from another AI model or a human and can select a trained AI model 220A-K based on the input.

The testing engine 320 may be capable of testing a trained AI model 220A-K using a corresponding set of features of a testing set from the training data engine 312. For example, a first trained AI model 220A-K that was trained using a first set of features of the training dataset may be tested using the first set of features of the testing set. The testing engine 320 can determine a trained AI model 220A-K that has the highest accuracy or other evaluation of all of the trained AI models 220A-K based on the testing sets.

As described above, the AI training subsystem 300 can be configured to train an LLM. It should be noted that the AI training subsystem 300 can train an LLM in accordance with implementations described herein or in accordance with other techniques for training LLMs. For example, an LLM may be trained on a large amount of data, including prediction of one or more missing words in a sentence, identification of whether two consecutive sentences are logically related to each other, generation of next texts based on prompts, etc.

In some embodiments, the AI model subsystem 330 selects an AI model 220A-K from the one or more AI models 220A-K. Selecting an AI model 220A-K may include selecting the AI model 220A-K for training or for use. For example, the training subsystem 310 can provide data to the AI model subsystem 330 indicating which AI model 220A-K is to be trained. The AI model subsystem 330 can obtain data from a component of the fraudulent action detection subsystem 114 indicating which AI model 220A-K to use to generate output.

FIG. 4 depicts one embodiment of an AI inference subsystem 116. The AI inference subsystem 116 may include one or more components configured to or programmed to provide input to one or more AI models, obtain output from the one or more AI models, and provide the output to other components of the system 100 (e.g., the fraudulent action detection subsystem 114).

In some embodiments, the AI inference subsystem 116 may include the AI model subsystem 330, which may include the one or more AI models 220A-K. In other embodiments, the AI model subsystem 330 may be located on a third-party server that is in data communication with the AI inference subsystem 116. The AI inference subsystem 116 may include an AI input/output component 410. The AI input/output component 410 may be configured to feed data as input to an AI model 220A-K and obtain one or more outputs. In such implementations, the AI input/output component 410 can feed an AI model input 210 to the AI model subsystem 330, and the AI model subsystem 330 may provide the AI model input 210 to the one or more AI models 220A-K. The one or more AI models 220A-K may perform inference calculations on the AI model input 210 and may provide their output to the AI input/output component 410. The AI input/output component 410 may generate the AI model output 230 based on the output(s) of the one or more AI models 220A-K.

In one embodiment, an AI model 220 may be a random forest. The random forest may include one or more decision trees. Different decision trees of the random forest may use different portions of the AI model input 210 to perform inferences. For example, a first decision tree may perform a first inference using a first subset of the compensation management data features 212A-D, and a second decision tree may perform a second inference using a second subset of the compensation management data features 212E-M. Two or more decision trees may use some of the same compensation management data features 212. For example, a first decision tree may use the compensation management data features 212A, C, E, and F, and a second decision tree may use the compensation management data features 212A, C, H, and J.

In some implementations, each AI model 220A-L may be a random forest, and each random forest may include decision trees trained or otherwise programmed to detect a specific type of fraud. For example, a first random forest may be trained or programmed to detect multiple users that have the same banking information, and a second random may be trained or programmed to detect fraud associated with user logins. Each random forest may aggregate the outputs of its respective decision trees to determine whether one or more user actions indicate fraud. For example, the output of a random forest may be based on a majority output of its decision trees.

In one or more embodiments, a random forest may provide, as part of its output, a confidence score indicating a confidence of the forest in its output. Responsive to the output of the random forest indicating that a user’s actions indicate fraud and a confidence score being below a threshold confidence value, the output of the random forest may be modified to not indicate fraud. A confidence value below a threshold value can indicate that the output may be a false positive. The confidence score associated with an output can assist the fraudulent action detection subsystem 114 to reduce occurrences of false positives. For example, while two users having the same banking information is often indicative of fraud, there may be some legitimate situations of two users sharing banking information (e.g., where two spouses work for the same organization and the organization deposits the spouses’ payments into a joint bank account). A random forest may produce an output indicating fraudulent action based on the two spouses sharing banking information, but other compensation management data features 212 may cause the AI model to produce a confidence score to be below the threshold confidence score value. Thus, the fraudulent action detection subsystem 114 may not determine that the two spouses sharing banking information constitutes fraud.

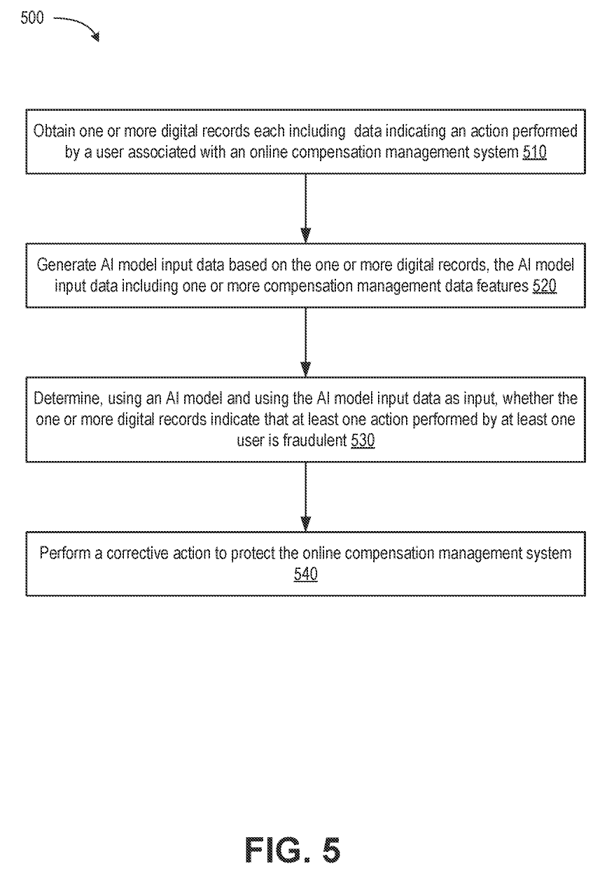

FIG. 5 illustrates an example method 500 for using AI to detect fraudulent actions on an online compensation management system 110, in accordance with one or more embodiments of the present disclosure. A processing device, having one or more central processing units (CPU(s)), one or more graphics processing units (GPU(s)), and/or memory devices communicatively coupled to the one or more CPU(s) and/or GPU(s) can perform the method 500 and/or one or more of the method’s 500 individual functions, routines, subroutines, or operations. In certain embodiments, a single processing thread can perform the method 500. Alternatively, two or more processing threads can perform the method 500, each thread executing one or more individual functions, routines, subroutines, or operations of the method. In an illustrative example, the processing threads implementing the method 500 can be synchronized (e.g., using semaphores, critical sections, and/or other thread synchronization mechanisms). Alternatively, the processing threads implementing the method 500 can be executed asynchronously with respect to each other. Various operations of the method 500 can be performed in a different (e.g., reversed) order compared with the order shown in FIG. 5. Some operations of the method 500 can be performed concurrently with other operations. Some operations can be optional. In some embodiments, the fraudulent action detection subsystem 114 performs one or more of the operations of the method 500.

At block 510, processing logic obtains, by a processing device, a one or more digital records 122A-M. Each digital record 122 may include data indicating an action performed by a user associated with an online compensation management system 110 of an organization. For example, the fraudulent action detection subsystem 114 may obtain the one or more digital records 122A-M from the datastore 120. In some embodiments, a first digital record 122A of the one or more digital records 122A-M may be a digital record 122 that the online compensation management system 110 generated or modified within a threshold amount of time and may indicate an action a user of the online compensation management system 110 recently performed. One or more second digital records 122B-M may include digital records 122 generated or modified by the online compensation management system 110 prior to generating or modifying the first digital record 122A and may indicate one or more actions that one or more users of the online compensation management system 110 performed in the past.

At block 520, processing logic generates an AI model input 210 based on the one or more digital records 122A-M. For example, the fraudulent action detection subsystem 114 may use data contained in the one or more digital records 122A-M as input to calculate or determine values to include in the AI model input 210. The AI model input 210 may include one or more compensation management data features 212A-L indicated by the one or more digital records 122A-M. The one or more compensation management data features 212A-L may include bank account data, employee login data, employee payroll setup data, employee payment history data, employee timekeeping data, or other compensation data.

At block 530, processing logic determines, using an AI model 220 and using the AI model input 210 as input, whether the one or more digital records 122A-M indicate that at least one action performed by at least one user is fraudulent. In one embodiment, the AI inference subsystem 116 may receive the AI model input 210 and provide the AI model input 210 to the one or more AI models 220A-K. In some embodiments, an AI model 220 may include a random forest. The decision trees of the random forest may obtain the AI model input 210 and perform inferences to determine whether the compensation management data features 212A-L indicate fraud. Different decision trees of the random forest may use different portions of the AI model input 210 to perform inferences. For example, a first decision tree of the random forest may perform a first inference using a first subset of the compensation management data features 212A-D, and a second decision tree may perform a second inference using a second subset of the compensation management data features 212E-M.

At block 540, responsive to the one or more digital records 122A-M indicating that the at least one action performed by the at least one user is fraudulent, processing logic performs a corrective action. The corrective action may protect the online compensation management system 110 of the organization. In one embodiment, performing the corrective action may include the compensation management subsystem 112 causing the online compensation management system 110 to prevent a change to a digital record 122A-M. Performing the corrective action may include the compensation management subsystem 112 causing the online compensation management system 110 to generate a fraudulent action alert. The alert may be presentable to an administrator of the online compensation management system 110 on a UI used by the administrator.

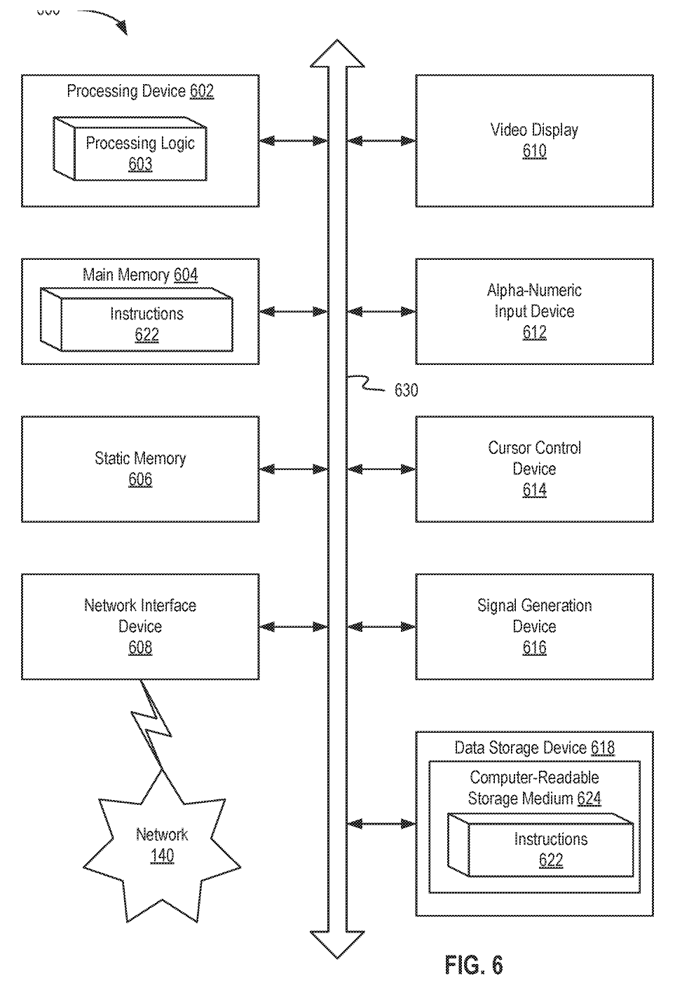

FIG. 6 depicts an example computer system 600 that can perform any one or more of the methods, processes, functions, operations, or the like that are described herein, in accordance with some embodiments of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of executable instructions to perform any one or more of the methods, processes, etc. discussed herein.

The example computer system 600 includes a processing device 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 618, which communicate with each other via a bus 630.

Processing device 602 (which can include processing logic 603) represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 622 for implementing the compensation management subsystem 112 and/or the fraudulent action detection subsystem 114 and to perform the operations discussed herein (e.g., the method 500).

The computer system 600 may further include a network interface device 608. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker). In one illustrative example, the video display unit 610, the alphanumeric input device 612, and the cursor control device 614 may be combined into a single component or device (e.g., an LCD touch screen).

The data storage device 618 may include a computer-readable storage medium 624 on which is stored the instructions 622 embodying any one or more of the methodologies or functions described herein. The instructions 622 may also reside, completely or at least partially, within the main memory 604 and/or within the processing device 602 during execution thereof by the computer system 600, the main memory 604 and the processing device 602 also constituting computer-readable media. In some implementations, the instructions 622 may further be transmitted or received over a network 140 via the network interface device 608.

While the computer-readable storage medium 624 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. A computer-readable storage medium may be non-transitory.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, which may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method, comprising:
obtaining, by a processing device, a plurality of digital records, wherein each digital record comprises data indicating an action performed by a user associated with an online compensation management system of an organization;
generating artificial intelligence (AI) model input data based on the plurality of digital records, wherein the AI model input data comprises a plurality of compensation management data features indicated by the plurality of digital records;
determining, using an AI model and using the AI model input data as input, whether the plurality of digital records indicate that at least one action performed by at least one user is fraudulent; and
responsive to the plurality of digital records indicating that the at least one action performed by the at least one user is fraudulent, performing a corrective action to protect the online compensation management system of the organization.

2. The method of claim 1, wherein the plurality of digital records comprises:
a first digital record generated by the online compensation management system within a threshold amount of time; and
one or more second digital records generated by the online compensation management system prior to generating the first digital record.

3. The method of claim 1, wherein the plurality of compensation management data features comprises at least one of:
bank account data;
employee login data; or
employee payroll setup data.

4. The method of claim 1, wherein the plurality of compensation management data features comprises at least one of employee payment history data or employee timekeeping data.

5. The method of claim 1, wherein:
the AI model comprises a random forest comprising a plurality of decision trees;
a first tree of the random forest performs a first inference using a first subset of the plurality of compensation management data features; and
a second tree of the random forest performs a second inference using a second subset of the plurality of compensation management data features.

6. The method of claim 1, further comprising training the AI model on a plurality of items of a training dataset, wherein a portion of the plurality of items comprises:
values for at least a portion of the plurality of compensation management data features indicating known instances of fraudulent actions; and
a target output indicating the fraudulent actions.

7. The method of claim 1, wherein performing the corrective action comprises at least one of:
causing the online compensation management system to prevent a change to a digital record of the plurality of digital records; or
causing the online compensation management system to generate a fraudulent action alert presentable to an administrator of the online compensation management system on a user interface (UI).

8. A system, comprising:
a memory; and
a processing device, coupled with the memory, configured to:
obtain, by a processing device, a plurality of digital records, wherein each digital record comprises data indicating an action performed by a user associated with an online compensation management system of an organization,
generate artificial intelligence (AI) model input data based on the plurality of digital records, wherein the AI model input data comprises a plurality of compensation management data features indicated by the plurality of digital records,
determine, using an AI model and using the AI model input data as input, whether the plurality of digital records indicate that at least one action performed by at least one user is fraudulent, and
responsive to the plurality of digital records indicating that the at least one action performed by the at least one user is fraudulent, perform a corrective action to protect the online compensation management system of the organization.

9. The system of claim 8, wherein the plurality of digital records comprises:
a first digital record generated by the online compensation management system within a threshold amount of time; and
one or more second digital records generated by the online compensation management system prior to generating the first digital record.

10. The system of claim 8, wherein the plurality of compensation management data features comprises at least one of:
bank account data;
employee login data; or
employee payroll setup data.

11. The system of claim 8, wherein the plurality of compensation management data features comprises at least one of employee payment history data or employee timekeeping data.

12. The system of claim 8, wherein:
the AI model comprises a random forest comprising a plurality of decision trees;
a first tree of the random forest performs a first inference using a first subset of the plurality of compensation management data features; and
a second tree of the random forest performs a second inference using a second subset of the plurality of compensation management data features.

13. The system of claim 8, wherein the processing device is further to train the AI model on a plurality of items of a training dataset, wherein a portion of the plurality of items comprises:
values for at least a portion of the plurality of compensation management data features indicating known instances of fraudulent actions; and
a target output indicating the fraudulent actions.

14. The system of claim 8, wherein performing the corrective action comprises at least one of:
causing the online compensation management system to prevent a change to a digital record of the plurality of digital records; or
causing the online compensation management system to generate a fraudulent action alert presentable to an administrator of the online compensation management system on a user interface (UI).

15. A non-transitory computer-readable storage medium comprising executable instructions that, when executed by a processing device, cause the processing device to:
obtain, by a processing device, a plurality of digital records, wherein each digital record comprises data indicating an action performed by a user associated with an online compensation management system of an organization;
generate artificial intelligence (AI) model input data based on the plurality of digital records, wherein the AI model input data comprises a plurality of compensation management data features indicated by the plurality of digital records;
determine, using an AI model and using the AI model input data as input, whether the plurality of digital records indicate that at least one action performed by at least one user is fraudulent; and
responsive to the plurality of digital records indicating that the at least one action performed by the at least one user is fraudulent, perform a corrective action to protect the online compensation management system of the organization.

16. The computer-readable storage medium of claim 15, wherein the plurality of digital records comprises:
a first digital record generated by the online compensation management system within a threshold amount of time; and
one or more second digital records generated by the online compensation management system prior to generating the first digital record.

17. The computer-readable storage medium of claim 15, wherein the plurality of compensation management data features comprises at least one of:
bank account data;
employee login data;
employee payroll setup data;
employee payment history data; or
employee timekeeping data.

18. The computer-readable storage medium of claim 15, wherein:
the AI model comprises a random forest comprising a plurality of decision trees;
a first tree of the random forest performs a first inference using a first subset of the plurality of compensation management data features; and
a second tree of the random forest performs a second inference using a second subset of the plurality of compensation management data features.

19. The computer-readable storage medium of claim 15, wherein the processing device is further to train the AI model on a plurality of items of a training dataset, wherein a portion of the plurality of items comprises:
values for at least a portion of the plurality of compensation management data features indicating known instances of fraudulent actions; and
a target output indicating the fraudulent actions.

20. The computer-readable storage medium of claim 15, wherein performing the corrective action comprises at least one of:
causing the online compensation management system to prevent a change to a digital record of the plurality of digital records; or
causing the online compensation management system to generate a fraudulent action alert presentable to an administrator of the online compensation management system on a user interface (UI).
